(19) United States
(12) Patent Application Publication
(10) Pub. No.: US 2013/0014286 A1
(43) Pub. Date: Jan. 10, 2013

(54) METHOD AND SYSTEM FOR MAKING EDRM-PROTECTED DATA OBJECTS AVAILABLE

(75) Inventors: Rainer Falk, Poing (DE); Steffen Fries, Baldham (DE); Stefan Seltzsam, Ismaning (DE)

(73) Assignee: SIEMENS AKTIENGESELLSCHAFT, Munich (DE)

(21) Appl. No.: 13/519,989

(22) PCT Filed: Dec. 15, 2010
(86) PCT No.: PCT/EP10/69782

§ 371 Date: Jun. 29, 2012

(30) Foreign Application Priority Data
Dec. 29, 2009 (DE) 10 2009 060 688.2
Feb. 1, 2010 (DE) 10 2010 006 432.7

(51) Int. Cl. G06F 21/24; G06F 21/00

(52) U.S. Cl. 726/30

(57) ABSTRACT

A method and a system make EDRM-protected data objects available to users. Access rights to an EDRM-protected data object are produced depending on partial access rights to at least one or more data objects, which data objects are contained in the respective EDRM-protected data object. The access rights to the EDRM-protected data object are calculated by a client computer of the user using an access right differentiation function depending on the partial access rights which are made available by different EDRM servers. A data object key of the EDRM-protected data object is calculated by the client computer of the user using a key differentiation function depending on partial keys which are made available by the different EDRM servers.

### CROSS REFERENCE TO RELATED APPLICATIONS

This application is based on and hereby claims priority to International Application No. PCT/EP2010/069782 filed on Dec. 15, 2010 and German Application Nos. 10 2009 060 688.2 filed on Dec. 29, 2009 and 10 2010 006 432.7 filed on Feb. 1, 2010, the contents of which are hereby incorporated by reference.

### BACKGROUND

The invention relates to a method and to a system for making EDRM (Enterprise Digital Rights Management)-protected data objects available to a user.

Enterprise Digital Rights Management (EDRM) provides access protection to data objects independently of their storage location. An EDRM-protected data object can be opened and then processed by an authorized user in accordance with his access rights that apply thereto. This occurs independently of the location at which the data object is stored or the manner in which it has been transferred. An unauthorized third party or outsider, who does not have access rights to access the data object, therefore cannot do anything with a copy by way of example of the data object, which he receives by email by way of example, or which he discovers on a USB stick that has been found. In other words, a third party cannot access the EDRM-protected data object.

To use such Enterprise Digital Rights Management (EDRM) the respective applications or application programs must be specially adapted for this purpose, however, i.e. the application programs must be expanded by an EDRM functionality. Therefore only application programs which have been specially adapted for this purpose can be used to utilize EDRM.

In an EDRM system an issuer of a data object, in particular a document, encrypts the data object before he releases it and also assigns access rights to the data object to specific users or user groups. This encrypted data object, including the associated access rights, is then transferred to an EDRM server. The issuer of the data object or document generates what is known as an issuance license (IL) which contains the access rights of users and user groups. The issuance license IL can indicate by way of example which users or which user groups are allowed to read, print or store the data object. In addition the issuance license IL contains a symmetrical cryptographic key which has been used by the issuer of the respective data object DO to encrypt the data object. Since the symmetrical cryptographic key DK, which is used to encrypt the data object, represents secret information, the issuance license IL generated by the producer or issuer of the data object is encrypted using a public key K_{pub} of the EDRM server and the issuer of the data object DO signs the issuance license IL. The document key DK for encrypting the data object DO can be randomly or pseudo randomly generated. The authorizations of the various users and user groups for the various types of access results from an access control list ACL which can be administratively determined. The access control list ACL indicates which users possess which access authorizations to the respective data object DO. Once the issuance license IL has been transferred from the data object issuer to the EDRM server the signature is verified by the EDRM server and then the issuance license IL transferred in encrypted form is decrypted by the EDRM server. The EDRM server stores the transferred information, i.e. the document key DK and the access control list ACL in particular. The issuance license IL can be changed by the data object issuer, by way of example if a person leaves a project or the data object DO is replaced by a newer version.

To use an EDRM-protected data object DO a user can access the EDRM server via an EDRM client to, by way of example, process the EDRM-protected data object. The EDRM client communicates with the EDRM server to obtain the symmetrical document key DK and to determine the access rights of the present data object in the form of what is known as an end user license EUL. This end user license EUL is only created by the EDRM server following authentication of the user against the EDRM server and is transferred to the corresponding EDRM client. The EDRM client passes the determined access rights to the EDRM-capable application program which is responsible for maintenance of the access rights. Decryption of the data object DO using the data object key DK occurs by way of the EDRM client, as does a potentially subsequently necessary renewed encryption of the data object. The EDRM client can keep the data object key DK secret even from a user with administration rights by way of example by code obfuscation or the like. The data object key can also be kept in the EDRM client in secured memory areas or even with the aid of a hardware security module (for example TPM—Trusted Platform Module).

However, conventional EDRM systems do not support access to data objects DO by users who work by way of example in different companies with different EDRM systems. Integration or collaboration of such users or applications, by way of example in the course of a joint venture by different companies, is not possible with conventional EDRM systems.

### SUMMARY

It is therefore one possible object to create a method and a system for making an EDRM-protected data object available which allows decentralized access to EDRM-protected data objects by users of different instances.

The inventors propose a method for making at least one EDRM (Enterprise Digital Rights Management)-protected data object DO available to a user, wherein access rights DP to the EDRM-protected data object DO are formed depending on partial access rights Pᵢ to at least one or more data object(s) which are contained in the EDRM-protected data object DO.

In an embodiment of the proposed method the access rights DP to the EDRM-protected data object DO are calculated by a client computer of the user by an access right derivation function PDF (Policy Derivation Function) depending on the access rights Pᵢ.

In one possible embodiment of the proposed method the access right derivation function PDF is formed by a logic function.

In one possible embodiment of the proposed method the logic access right derivation function PDF forms an intersection of the partial access rights Pᵢ.

In a further embodiment of the proposed method the logic access right derivation function PDF forms a union of the partial access rights Pᵢ.

In a further embodiment of the proposed method the local access right derivation function PDF forms a difference of the partial access rights Pᵢ.

In one possible embodiment of the proposed method the access right derivation function PDF is formed by a majority decision of the partial access rights read out by different EDRM servers.

In one embodiment of the proposed method a data object key DK of the EDRM-protected data object DO is calculated by the client computer of the user depending on partial keys Kᵢ.

In one embodiment of the proposed method a data object DO generated by the client computer is encrypted using the calculated data object key DK.

In one embodiment of the proposed method the data object key DK is calculated by a key derivation function KDF.

In one embodiment of the proposed method the key derivation function KDF is a logic function.

In a further possible embodiment of the proposed method the key derivation function KDF is a concatenation function.

In a further possible embodiment of the proposed method the key derivation function KDF is a hash function.

In a further possible embodiment of the proposed method the key derivation function KDF has a combination of various functions, in particular a concatenation function, a hash function and a logic function.

In one embodiment of the proposed method the partial access rights Pᵢ are made available for access to the data objects contained in the EDRM-protected data object and the partial key K is made available for calculating the data object key from different EDRM servers.

In one embodiment of the proposed method the partial access rights Pᵢ and the partial keys Kᵢ are transferred from the EDRM servers to the client computer of the user following authentication of the user against the respective EDRM server at the user's request by giving the document identification D-ID of the data object DO.

In one embodiment of the proposed method an associated right object RO is generated which gives access rights Pᵢ of users or user groups to the generated data object DO for a data object DO generated by the client computer of the user.

In one embodiment of the proposed method the right object RO associated with the data object DO is encrypted using a public key K_{pub} of an EDRM server and together with the data content DI, encrypted by the calculated data object key DK, of the data object DO, and the document identification D-ID of the data object is transferred in signed form to the respective EDRM server.

In one embodiment of the proposed method the EDRM server decrypts the right object RO transferred in encrypted form using a private key Kₚᵣᵢᵥ of the EDRM server and stores the decrypted right object RO following verification of the received signature.

In one embodiment of the proposed method the EDRM server decrypts the data content of the data object DO transferred in encrypted form using the data object key DK of the data object and stores the decrypted data content following verification of the received signature.

In one embodiment of the proposed method the EDRM server stores the decrypted data content of the data object or the still encrypted data content of the data object in itself.

In an alternative embodiment of the proposed method the EDRM server stores the decrypted data content of the data object in a file server.

In one embodiment of the proposed method the data object DO is formed by a document.

In an alternative embodiment of the proposed method the data object DO is formed by a software component.

The inventors also propose a system for making EDRM-protected data objects available to users, wherein access rights DP to an EDRM-protected data object DO are formed depending on partial access rights Pᵢ to at least one of more data object(s) which are contained in the respective EDRM-protected data object DO.

In one embodiment of the proposed system the access rights DP to the EDRM-protected data object DO are calculated by a client computer of the user by an access right derivation function PDF depending on the partial access rights Pᵢ which are made available by different EDRM servers.

In one embodiment of the proposed system a data object key DK of the EDRM-protected data object is calculated by the client computer of the user by a key derivation function KDF depending on partial keys Kᵢ which are read out by different EDRM servers.

In one possible embodiment of the proposed system the client computer is connected to the EDRM servers by a data network.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a diagram to illustrate an exemplary embodiment of a proposed system for making the EDRM-protected data object available,

FIG. 2 shows a signal diagram to illustrate a step in the proposed method,

FIG. 3 shows a further signal diagram to illustrate a step in the proposed method.

FIG. 4 shows a further signal diagram to illustrate a further step in the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

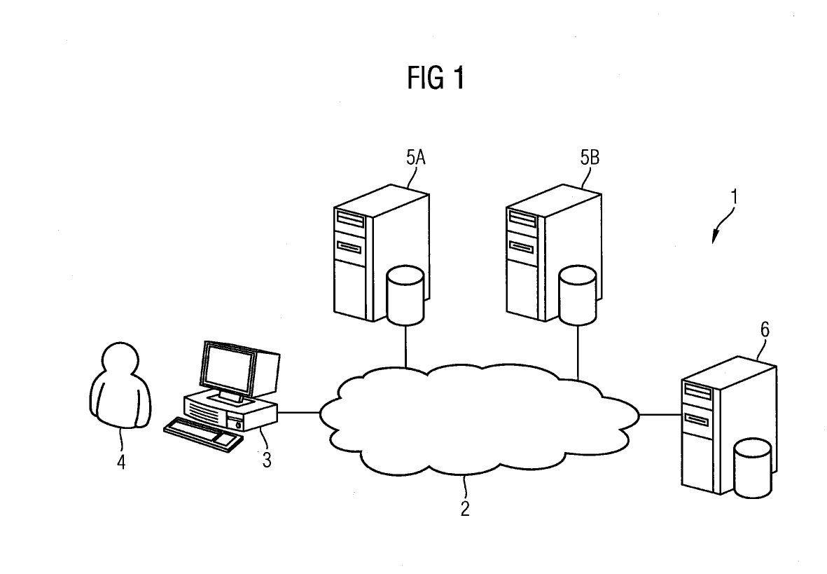

As may be seen from FIG. 1, a proposed system 1 for making EDRM-protected data objects available comprises in the exemplary embodiment illustrated in FIG. 1 a data network 2 to which at least one client computer 3 of a user 4 is connected. Two EDRM servers 5A, 5B are also provided in the exemplary embodiment illustrated in FIG. 1. The number of EDRM servers 5 can vary. In further exemplary embodiments the number of EDRM servers 5 can by way of example be more than 2. A file server 6 is also connected to the network 2 in the exemplary embodiment of the proposed system 1 illustrated in FIG. 1. The network 2 can be any desired network, by way of example a network which is composed of a plurality of networks. The network 2 can by way of example be the Internet. The network 2 can also be a local (LAN) or Wide Area Network (WAN). The client computer 3 and the EDRM server 5 and the file server 6 are connected to the data network 2 by an interface. The interface can be wireless or wired. The client computer 3 can be a fixed device but also a mobile terminal. In the system 1 access rights DP to an EDRM-protected data object DO are formed depending on partial access rights Pᵢ to at least one or more data object(s) which are contained in the respective EDRM-protected data object DO. The access rights DP to the EDRM-protected data object DO are calculated by the client computer 3 of the user 4 by an access right derivation function PDF (Policy Derivation Function) depending on the partial access rights Pᵢ. These partial access rights Pᵢ are made available by the different EDRM servers 5A, 5B.

The access right derivation function PDF can be a logic function. In one possible embodiment the logic access right derivation function PDF is formed by an intersection of the partial access rights Pᵢ, i.e. by a logic AND operation of the partial access rights Pᵢ. This means that access authorization is granted by a plurality of partial policies:

DP=P₁∩P₂∩ . . . Pₙ

In a further embodiment the logic access right derivation function PDF is formed by a union of the partial access rights Pᵢ i.e. the partial access rights Pᵢ are linked together by a logic OR operation. In this case access authorization must be granted by one of the partial policies:

DP=P₁∪P₂∪ . . . Pₙ

In a further embodiment of the proposed system the logic access right derivation function PDF is formed by a difference of the partial access rights Pᵢ. This means that access authorization is granted by a first partial policy P₁ but not by a second partial policy P₂:

DP=P₁/P₂

In a further possible embodiment the access right derivation function PDF is formed by a majority decision of the partial access rights Pᵢ read out by different EDRM servers 5. If, by way of example, there are two EDRM servers 5A, 5B, in this exemplary embodiment more than 50%, i.e. both EDRM servers 5A, 5B, must grant the access rights. If there are three EDRM servers, at least two of the three EDRM servers must grant the access rights. EDRM servers 5, which owing to a temporary failure have not implemented all right updates, but in the meantime are issuing end user licenses (EUL) again, can consequently be overruled. The failure of one EDRM server 5 can also be ignored by the EDRM client computer 3 in this case (in contrast to a pure AND operation of the partial access rights).

In one possible embodiment the client computer 3 has various access right derivation functions PDF from which the user 4 can choose or which the user 4 can select. In one embodiment of the proposed system 1 a data object key DK of the EDRM-protected data object DO is calculated by the client computer 3 of the user 4 by a key derivation function KDF depending on partial keys Kᵢ which are read out from different EDRM servers 5A, 5B. A data object DO generated by the client computer 3 is encrypted using the calculated data object key DK.

This data object key DK is calculated by the key derivation function KDF. In one possible embodiment the key derivation function KDF is a logic operation. The logic function can by way of example be an exclusive OR operation. In a further embodiment the key derivation function KDF is a concatenation function in which various keys Kᵢ are appended one after the other. In a further embodiment the used k key derivation function KDF is a hash function, in particular an MD5, an SHA-1 or an SHA256 hash function. The key derivation function KDF can also be formed by a combination of various functions of different types, by way of example a hash function and a logic operation of keys, by way of example SHA256 (K₁ XOR K₂).

The following generally applies for determining the access rights DP to the EDRM-protected data object DO depending on partial access rights Pᵢ in the case of a plurality of EDRM servers 5:

DP=PDF(P₁,P₂, . . . Pₙ)

The following generally applies for calculating the data object key DK using a key derivation function KDF comprising a plurality of partial keys Kᵢ which can be read out by different EDRM servers 5:

DK=KDF(K₁,K₂, . . . Kₙ).

The partial access rights Pᵢ to access the data objects contained in the EDRM-protected data object DO, and the partial keys Kᵢ for calculating the data object key DK are read out by different EDRM servers 5.

In one possible embodiment of the proposed system 1 the partial access rights Pᵢ and the partial keys Kᵢ are transferred from the EDRM servers 5 to the client computer 3 of the user following authentication of the user against the respective EDRM servers 5 at the user's request by giving the document identification D-ID of the data object. An associated right object RO can be generated for a data object DO generated by the client computer 3 of the user 4 in the process, the right object giving access rights Pᵢ of users or user groups to the generated data object. The right object RO associated with the data object DO and encrypted using a public key K_{pub} of an EDRM server 5 can preferably be transferred in signed form to the respective EDRM server 5 together with the data content DI of the data object DO, encrypted by the calculated data object key DK, and the document identification D-ID of the data object. Following verification of the received signature the EDRM server 5 decrypts the right object RO transferred in encrypted form using a private key Kₚᵣᵢᵥ and stores the encrypted right object RO. Following verification of the received signature the EDRM server 5 also decrypts the data content of the data object DO transferred in encrypted form using the data object key DK of the respective data object and stores the decrypted data content. The EDRM server 5, by way of example the EDRM server 5A or 5B in FIG. 1, can store the decrypted data content of the data object DO in a storage unit in itself or in the file server 6 illustrated in FIG. 1.

With the proposed system 1, as is shown in FIG. 1, control over the EDRM protection of a data object can be divided among a plurality of participants. In particular it is possible that none of the EDRM servers 5 alone has the document key DK. This is advantageous in particular for a collaborative operational environment or use in which EDRM-protected data objects DO are created and exchanged across organizations. In this case one participant does not have sole control over which users or user groups can access a data object DO. The data object DO is a document by way of example. It is also possible for the data object DO to be a software component. This software component is executable program code by way of example. The software component may also be a Virtual Machine (VM), in particular a Virtual Box.

It is also ensured with the proposed system 1 that certain restrictions, which are specified on a different EDRM server, cannot be evaded as a result of configuration errors on one EDRM server 5.

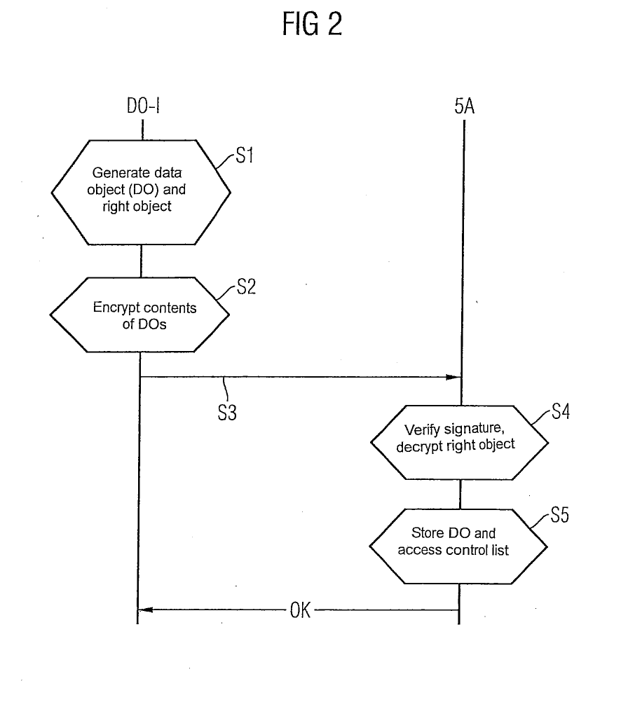

FIG. 2 shows a signal diagram to illustrate the proposed method step of the proposed method.

FIG. 2 shows how a data object can be protected by the proposed system 1 and method by storing partial items of information, in particular partial policies or partial access rights Pᵢ and partial keys Kᵢ. A data object issuer or (DO-I) generates a data object DO. The data object can be generated by way of example by a user 4 on a client computer 3.

As FIG. 2 shows, in a step S1 the data object issuer DO-I generates the data object and an associated right object which give partial access rights Pᵢ of users or user groups to the generated data object DO. The right object RO can be an issuance license IL by way of example. As a right object this issuance license IL comprises by way of example the document key DK and an access control list ACL which gives the access rights of users or user groups to the respective data object which has a certain document ID D-ID. In a step S2 the data contents of the data object DO are encrypted and signed. The right object RO associated with the data object DO is encrypted by way of example using a public key K_{pub} of an EDRM server 5 and together with the data contents DI of the data object DO, encrypted by the calculated data object key DK, and the document identification D-ID of the data object DO is transferred in signed form to the respective EDRM server 5, by way of example to the EDRM server 5A illustrated in FIG. 2, in a step S3. The data is transferred by way of example from the client computer 3 to the EDRM server 5A via the network 2. The received signature is firstly verified in a step S4 by the EDRM server 5A and then the transferred right object RO or the Issue License IL is decrypted using a private key Kₚᵣᵢᵥ of the EDRM server 5A. The decrypted right object RO can then be stored in the EDRM server 5A. In a further step S5 the EDRM server 5A stores the data object key DK of the data object and the associated access control list ACL. This access control list ACL codes which users have which access authorizations to this data object DO. The access authorizations or access control list ACL can be determined by an administrator by way of example.

In step S2 shown in FIG. 2 the data object generated by the client computer 3 is encrypted using a data object key DK which is calculated by the client computer 3 depending on partial keys Kᵢ. This data object key DK is calculated by way of example by a stored key derivation function KDF. This key derivation function KDF can be a logic function. Alternatively the key derivation function KDF may be a concatenation function, a hash function or a combination of various key derivation functions. The right object RO associated with the data object or the Issue License IL is encrypted using the public key K_{pub} of the EDRM server 5A and together with the data content of the data object, encrypted by the calculated data object key, and the document identification D-ID of the data object is transferred in signed form to the EDRM server 5A in step S3.

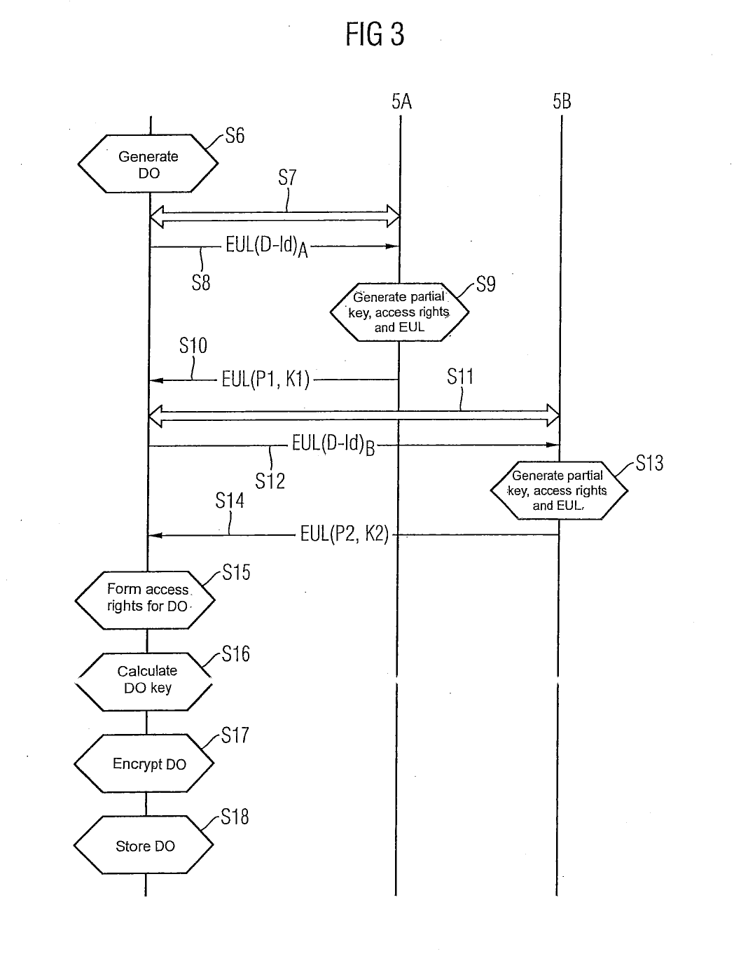

Partial items of information are stored on the EDRM server 5A, i.e. a partial policy or access rights Pᵢ and partial keys Kᵢ. FIG. 3 shows a further signal diagram to illustrate the generation of an EDRM-protected data object. In a step S6 a data object generator, by way of example a user 4, by way of example in a company C, generates or produces a data object, in particular a document, on his client computer 3 with a clear data object identification (D-ID). This data object DO can be formed of a plurality of partial data objects. A generated document can comprise by way of example two partial documents D_{A}, D_{B} from different, collaborating companies A. B. In a further step S7 the user 4 is identified against a first EDRM server 5A in the illustrated example. This EDRM server 5A can be the EDRM server of the company A by way of example. Once the user has been authenticated, in a step S8 the user transfers a request to the EDRM server 5A for an end user license EUL for the partial data object D_{A} contained in the generated data object DO identified by the document ID. In a further step S9 the EDRM server 5A determines a partial key K₁ and the user access rights P1 for the respective partial data object, i.e. for the partial data object D_{A}. The EDRM server 5A creates a corresponding end user license EUL and transfers this EUL (P1, K1) in step S10 to the generator or the data object DO. The data object generator authenticates himself further in a step S11 against the second EDRM server 5B and then asks for an end user license EUL for the other partial data object D_{B} using the data object ID_{B} thereof from this second EDRM server 5B in step S12. In the illustrated example the generated document DO can comprise two partial documents D_{A}, D_{B} which are identified by different document or data object IDs D-ID_{A}, D-ID_{B}. A first EUL is transferred in step S8 for document ID D-ID_{A} and a request for a further EUL is transferred in the request in step S12 for data object D_{B} with the ID D-ID_{B}. In step S13 the second EDRM server 5B determines the document key K₂ or partial key K₂ for the second data object or document D_{B} and the associated access rights P₂ for this second partial data object D_{B}. The second EDRM sever 5B can be located in a second company B by way of example. In a further step S14 the second EDRM server 5B transfers the determined partial key K₂ and the access rights P₂ to the partial data object K₂ via the network 2 to the document generator who generated the data object DO formed of the two partial documents D_{A}, D_{B}, This document generator is by way of example a user belonging to a further company C who creates the document on the basis of documents belonging to company A and company B.

In a further step S15 the access rights DP to the data object DO are formed depending on the partial access rights P₁, P₂, received in step S10 and in step S14, to the data object D_{A} and D_{B}, which are contained in the EDRM-protected data object DO. These access rights DP to the data object DO are preferably calculated by a client computer 3 of the user 4, which in the given example is the document generator for the data object DO, by an access right derivation function PDF depending on the partial access rights P₁, P₂. This access right derivation function PDF is by way of example a logic function which forms an intersection of the partial access rights P₁, P₂ or a union of the partial access rights P₁ and P₂ or a difference of the partial access rights P₁ and P₂. The access right derivation function PDF can also be formed by a majority decision of the time access rights P₁ and P₂ read out by the different EDRM servers 5A, 5B.

In a step S16 a data object key DK of the EDRM-protected data object DO is calculated depending on the two partial keys K₁, K₂ transferred in steps S10 and S14. The data object generated by the data object generator in step S6 is then encrypted in step S17 using the data object key DK calculated in step S16. The data object key DK is calculated in step S16 preferably by a stored key derivation function KDF. This key derivation function KDF can be a logic function, a concatenation function, a hash function or a combination of various functions of this kind.

The EDRM-protected data object is then stored in step S18, by way of example in a memory area of the client computer 3 of the respective user.

As may be seen from FIG. 3, the partial access rights P₁, P₂ to access the two data objects DA, DB contained in the EDRM-protected data object DO, and the associated partial keys K₁, K₂ for calculating the data object key DK are read out by different EDRM servers 5A, 5B. The partial access rights P₁, P₂ and the partial keys K₁, K₂ are only transferred from the EDRM servers 5A, 5B to the client computer 3 of the user following authentication of the user against the respective EDRM servers 5A, 5B at the user's request by giving the document identification D-ID of the respective data object.

In one possible embodiment the access right derivation function PDF and the key derivation function KDF are stored in publically accessible form on a server of the network 2 and can be downloaded as required.

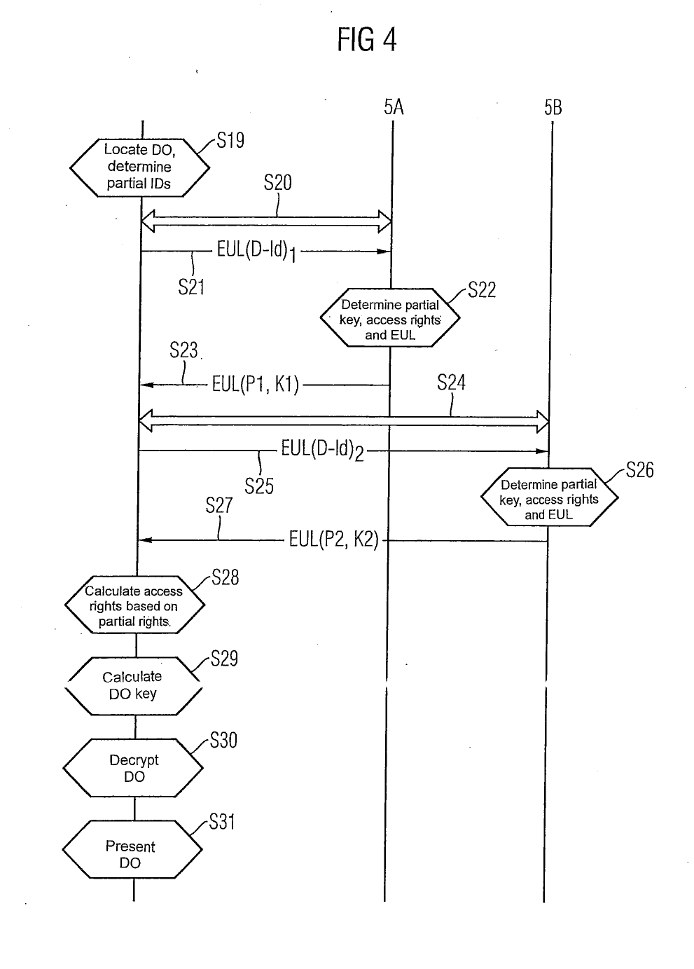

FIG. 4 shows a further signal diagram to illustrate a further portion of the proposed method. FIG. 4 illustrates how a data object DO can be used by a user. This user can be a user 4 who has access to the EDRM servers 5A, 5B via a client computer 3. The user can by way of example be an employee of a further company D who wishes to access the EDRM-protected data object DO generated by company C and which is made up of data objects D_{A}, D_{B}, belonging to companies A, B. In a step S19 the user finds the EDRM-protected data object DO, which has a certain data object identification D-ID, and wishes to access this data object DO, i.e. by way of example read it or process it in some other way. Following authentication of the user against the EDRM server 5A in step S20 the user sends a request for transfer of an end user license EUL for partial document D_{A} with identification D-ID_{A} in step S21. The EDRM server 5A determines the document partial key K₁ and the partial access right P₁ for this data document D_{A} in step S22 and transfers the determined partial access rights P₁ and the partial key K₁ within an end user license EUL in step S23 to the requesting user. He authenticates himself in step S24 against the second EDRM server 5B as well and in step S25 also demands an end user license EUL for the second partial document D_{B} with document ID D-ID_{B} from the second server 5B. In step S26 the second EDRM server 5B determines the partial access rights Rand partial key K₁ for the data object D_{B} and transfers these in an end user license EUL in step S27 to the requesting user. In a further step S28 the access right derivation function PDF is calculated for the access rights DP of the user to the EDRM-protected data object DO, which is made up of the data objects D_{A}, D_{B}. The access rights DP of the user to the EDRM-protected data object are formed depending on the partial access rights P₁, P₂ to the two data objects D_{A}, D_{B}, which are contained in the EDRM-protected data object DO.

In a further step S29 a data object key DK is calculated for the EDRM-protected data object DO by a key derivation function KDF. The EDRM-protected data object is then decrypted in step S30 using the calculated data object key DK. The data object DO is then made available to the user in step S31 in accordance with the access rights DP determined for this EDRM-protected data object.

As may be seen from FIG. 4, partial items of information from two different EDRM servers 5A, 5B are requested when accessing an EDRM-protected data object DO, and the received items of information are linked to determine or calculate the document key DK and the access rights DP or the document policy DP to the EDRM-protected data object.

The proposed method can be implemented by an application program with program commands to carry out the method. In one possible embodiment this application program is stored on a data carrier which can be read out by a read-out unit of a client computer 3. In an alternative embodiment the client computer 3 downloads the application program, stored in a server, via the network 2. The access right derivation function PDF and the key derivation function KDF can be stored on a server so as to be publically accessible and can be downloaded by the client computer 3.

The access right derivation function PDF and the key derivation function KDF can be implemented in the application program.

In an alternative embodiment of the proposed system the access right derivation function PDF and the key derivation function KDF are secret or not publically accessible and are made available to the users by way of example only after corresponding authentication. In one possible embodiment of the proposed system 1 the access right derivation function PDF and the key derivation function KDF are implemented in terms of hardware or wiring in a calculating unit of the client computer 3, or may be provided so as to be hard-wired. In one possible embodiment a user 4 cannot read out the access right derivation function PDF and the key derivation function KDF implemented on his client computer 3. In one possible embodiment the access right derivation function PDF made available and the key derivation function KDF made available in system 1 can be changed in certain intervals, i.e. the functions are replaced by a different function by certain intervals.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-20. (canceled)

21. A method for making an EDRM (Enterprise Digital Rights Management)-protected data object available to a user, comprising:
forming access rights to the EDRM-protected data object depending on partial access rights to corresponding data partial objects which are contained in the EDRM-protected data object.

22. The method as claimed in claim 21, wherein the access rights to the EDRM-protected data object are calculated by a client computer of the user using an access right derivation function that depends on the partial access rights.

23. The method as claimed in claim 22, wherein the access right derivation function is a logic function.

24. The method as claimed in claim 23, wherein the access right derivation function calculates access rights from an intersection of the partial access rights, or wherein the access right derivation function calculates access rights from a union of the partial access rights, or wherein the access right derivation function calculates access rights from a difference of the partial access rights.

25. The method as claimed in claim 22, wherein
the partial access rights read are out by different EDRM servers, and
the access right derivation function calculates access rights from a majority decision of the partial access rights read out by the different EDRM servers.

26. The method as claimed in claim 22, wherein
the data partial objects have associated partial keys, and
a data object key of the EDRM-protected data object is calculated by the client computer of the user depending on the partial keys.

27. The method as claimed in claim 26, wherein
the EDRM-protected data object is based on an unprotected data object generated by the client computer of the user, and
the EDRM-protected data object is generated by encrypting the unprotected data object using the data object key calculated by the client computer.

28. The method as claimed in claim 26, wherein the data object key is calculated by a key derivation function.

29. The method as claimed in claim 28, wherein the key derivation function comprises at least one of a logic function, a concatenation function and a hash function.

30. The method as claimed in claim 26, wherein
the partial access rights are made available for access to the data partial objects contained in the EDRM-protected data object, and
the partial keys are made available from different EDRM servers for calculation of the data object key.

31. The method as claimed in claim 30, wherein
the partial access rights and the partial keys are transferred from respective different EDRM servers to the client computer of the user following authentication of the user against the respective EDRM servers at the user's request by the user giving a document identification of the data object.

32. The method as claimed in claim 27, wherein
for the unprotected data object generated by the client computer of the user, an associated right object is generated which gives access rights of users or user groups to the EDRM protected data object.

33. The method as claimed in claim 32, wherein
the right object is encrypted using a public key of a designated EDRM server, to thereby produce an encrypted right object,
data content of the unprotected data object is encrypted using the data object key, to thereby produce encrypted data content, and
a document identification of the EDRM protected data object, the encrypted right object and the encrypted data content are transferred in signed form to the designated EDRM server.

34. The method as claimed in claim 33, wherein
the designated EDRM server verifies a signature used to sign the document identification, the encrypted right object and the encrypted data content,
after verification, the designated EDRM server decrypts the encrypted right object using a private key of the designated EDRM server, to regenerate the right object, and
after decryption, the designated EDRM server stores the right object.

35. The method as claimed in claim 34, wherein
the designated EDRM server verifies a signature used to sign the document identification, the encrypted right object and the encrypted data content,
after verification, the designated EDRM server decrypts the encrypted data content using the data object key to regenerate the data content, and
after decryption, the designated EDRM server stores the data content.

36. The method as claimed in claim 34, wherein
the designated EDRM server stores the data content in encrypted or decrypted form, and
the designated EDRM server stores the data content in the designated EDRM server or in a file server.

37. The method as claimed in claim 36, wherein the EDRM protected data object is a protected document or software component.

38. A system to provide a EDRM-protected data object to a user, comprising:
a computer to form access rights to the EDRM-protected data object depending on partial access rights to corresponding data partial object which are contained in the EDRM-protected data object.

39. The system as claimed in claim 38, wherein
the partial access rights are made available by different EDRM servers, and
the access rights to the EDRM-protected data object are calculated by a client computer of the user by an access right derivation function depending on the partial access rights which are made available by the different EDRM servers.

40. The system as claimed in claim 38, wherein
the data partial objects have associated partial keys,
the partial keys are made available by different EDRM servers, and
a data object key of the EDRM-protected data object is calculated by a client computer of the user by a key derivation function depending on the partial keys which are made available by the different EDRM servers.
